(19) United States
(12) Patent Application Publication
(10) Pub. No.: US 2015/0156014 A1
(43) Pub. Date: Jun. 4, 2015

(54) Method And Apparatus For ONU Authentication

(71) Applicant: Alcatel-Lucent USA Inc., Murray Hill, NJ (US)

(72) Inventors: Michael R. Shaffer, Longwood, FL (US); Julia G. Ferguson, Raleigh, NC (US)

(73) Assignee: Alcatel-Lucent USA Inc., Murray Hill, NJ (US)

(21) Appl. No.: 14/143,434

(22) Filed: Dec. 30, 2013

Related U.S. Application Data
(60) Provisional application No. 61/910,495, filed on Dec. 2, 2013.

(51) Int. Cl. H04L 9/08; H04Q 11/00

(52) U.S. Cl. CPC H04L 9/0819; H04Q 11/0067; H04Q 2011/0079; H04L 2209/24

(57) ABSTRACT

A manner of authenticating subscriber devices for operation in an optical access network, such as ONUs attempting to access a PON. When a managing node such as an OLT in a PON detects a subscriber device, it sends a request for a text string or password, which is presumably resident on the subscriber device and known to the managing node.

The request contains an encryption key, which may, after validation by the subscriber device, be loaded into a register. The subscriber device then uses the encryption key in conjunction with a preferably proprietary and embedded encryption algorithm to encrypt the test string or password prior to transmitting it in reply to the request. The managing node may then evaluate the reply message and the encryption or lack thereof of the text string or password prior to determining whether to authorize access by the subscriber device.

### CROSS-REFERENCE TO RELATED APPLICATIONS

The present disclosure is related to and claims priority from U.S. Provisional Patent Application Ser. No. 61/910495, entitled Apparatus and Method for ONU Authentication, and filed on 2 Dec 2013, the entire contents of which are incorporated by reference herein.

### TECHNICAL FIELD

The present invention relates generally to the field of communication networks, and, more particularly, to a method and apparatus for authentication of a subscriber device, for example an ONU attempting to operate in an optical access network such as a PON.

### BACKGROUND

The following abbreviations are herewith defined, at least some of which are referred to within the following description of the state-of-the-art and the present invention.
CO Central Office
GPON Gigabit PON
OLT Optical Line Terminal
ONT Optical Network Terminal
ONU Optical Network Unit
PLOAM Physical Layer Operations and Maintenance
PON Passive Optical Network
SoC System on Chip

An optical access network typically includes one or more management devices or nodes that handle the communications between a core communication network and a number of subscriber devices. These subscriber devices are located at the premises of subscribers themselves and communicate with the managing node over one or more fiber optic cables. When a new subscriber device attempts to join such a network, the managing node typically asks for a serial number or similar identifier in an effort to ensure that the new device is a legitimate product properly purchased for this implementation. This procedure may be to determine that a particular subscriber device is suitable for proper operation within the access network or to protect a service provider's licensing rights, or both.

Unfortunately, illegitimate devices may pirate the identification serial numbers of legitimate ones, and attempt to emulate the legitimate subscriber device. A more robust manner of authenticating subscriber devices is therefore needed. This need is addressed by the present invention.

Note that the techniques or schemes described herein as existing, possible, or desirable are presented as background for the present invention, but no admission is made thereby that these techniques and schemes or the need for them were heretofore commercialized or known to others besides the inventors.

### SUMMARY

The present invention is directed to a manner of authenticating subscriber devices for operation in an optical access network. In one aspect, the present invention is a method of authenticating a subscriber device for operation in an optical access network, including receiving a request at a subscriber device; the request comprising an encryption key, encrypting at least a portion of a response using the encryption key, and transmitting the encrypted response from the subscriber device. The encryption response portion may include a text string or password known to a managing node. In a preferred embodiment, the request also includes a key validation code and the method further includes determining whether the key is valid. In this preferred embodiment, if the key is determined to be valid, it is loaded into a key register; if not, a null value is loaded.

In some embodiments, the method further includes detecting the subscriber device by a managing node of the optical access network and transmitting the request. The method may also include receiving the at least partially encrypted response at a network authentication device and evaluating the response. Evaluating the response may include determining whether the encrypted portion of the response has been properly encrypted according to a known encryption algorithm. The response may be decrypted prior to the evaluation. Embodiments of the invention may also include determining whether to authenticate the subscriber device for network operation based at least in part on the evaluation.

The subscriber device may be an ONU attempting operation as part of a PON, and the managing node may be an OLT. In, for example, a GPON, the authentication-related request may be a PLOAM message, and the at least partially encrypted response include a PLOAM password.

In still yet another aspect, the present invention provides a .

In yet another aspect, the present invention provides a network that includes to a protection state.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 is a schematic diagram illustrating selected components of a PON in which the present invention may be advantageously implemented;

FIG. 2 is a flow diagram illustrating an authentication method according to an embodiment of the present invention;

FIG. 3 is a flow diagram illustrating an authentication method according to another embodiment of the present invention;

FIG. 4 is a message flow diagram illustrating an authentication method according to another embodiment of the present invention;

FIG. 5 is a simplified block diagram illustrating selected components of a managing node configured according to an embodiment of the present invention; and

FIG. 6 is a simplified block diagram illustrating a subscriber device configured according to an embodiment of the present invention.

### DETAILED DESCRIPTION

The present invention is directed to a manner of authenticating subscriber devices for operation in an optical access network. As mentioned above, simply requesting the serial number of such devices is often unsatisfactory as illegitimate devices may be equipped with pirated serial numbers. The present invention is intended to make such authentication pirating much more difficult in a manner that is nevertheless practical to implement at a low cost in terms of money or performance.

The present invention will now be described in terms of authenticating ONUs (optical network units) in a PON. It should be recognized, however, that the present invention has applicability for use in other optical network devices and other networks as well. It is noted here that herein the term “ONU” is meant to include all subscriber-based optical network components, usually representing the termination of an optical access network at the subscriber side. The present invention is of particular advantage in PONs in part because of their widespread use. In addition the components in a PON are usually geographically widely-dispersed, and are often located on private property where they may be inconvenient to access.

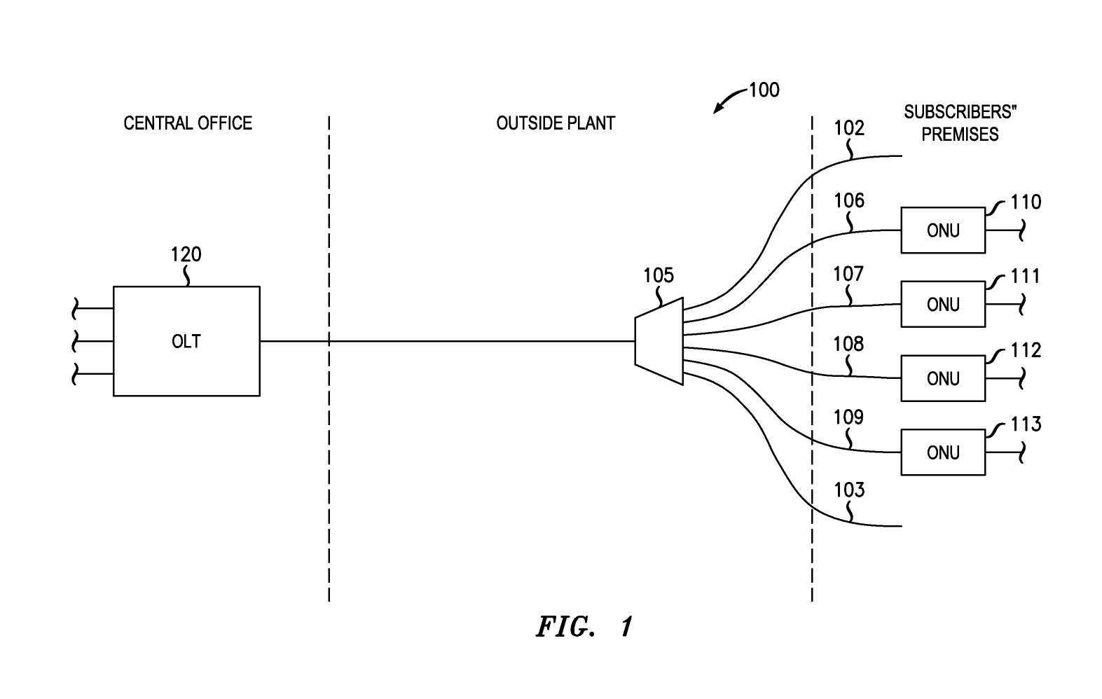

FIG. 1 is a schematic diagram illustrating selected components of a PON 100 in which the present invention may be advantageously implemented. Note that PON 100 may, and in many implementations will, include additional components, and the configuration shown in FIG. 1 is intended to be exemplary rather than limiting. Four ONUs, 110 through 113, are shown, although in a typical PON there may be many more or, in some cases, fewer. In this illustration, each of the ONUs are presumed to be located at and serving a different subscriber, perhaps at their respective residences or other premises. The ONU at each location is connected or connectable to a device of the subscriber, or to a network of such devices (not shown).

PON 100 also includes an OLT 120, which communicates directly or indirectly with various sources of content and network-accessible services (not shown) that are of interest to the subscribers associated with ONUs 110 through 113. As should be apparent, OLT 120 handles the communications between these other entities and the ONUs. OLT 120 may also be involved in regulating the PON and individual ONUs. The OLT 120 is typically located at a service provider location referred to generally as a central office. The central office may house multiple OLTs (not separately shown), each managing their own respective PON.

OLT 120 is in at least optical communication with each of the ONUs in the PON 100. In the embodiment of FIG. 1, OLT is connected with the ONUs 110 through 113 via a fiber optic cable 101 and fiber optic cables 106 through 109. In this PON, a single splitter 105 is used to distribute a downstream transmission so that each ONU receives the same downstream signal. In other optical networks, the splitter may also separate the different wavelengths, if used, associated with each of the respective ONUs. The splitter in a PON is typically a passive element requiring no power. The splitter may also serve as a combiner for combining upstream traffic from the ONUs to the OLT. The splitter may be located, for example, in a street-side cabinet near the subscribers it serves (FIG. 1 is not necessarily to scale). This cabinet or similar structure may be referred to as the outside plant. Note, however, that no particular network configuration is a requirement of the present invention unless explicitly stated or apparent from the context.

Also illustrated in FIG. 1 are fiber optic cables 102 and 103, which are also connected to optical splitter 105 and which may in the future be connected to ONUs (not shown) yet to be installed. With some network providers, this installation is closely monitored and only certain equipment is used. In other implementations, the subscriber or another contractor may simply purchase an ONU and install it themselves, for example by connecting to one of fiber optic cables 102 or 103. Some of these self-installed ONUs are legitimate, but pirated devices may be available. Application of the present invention to PON 100 can frustrate the use of these pirated devices.

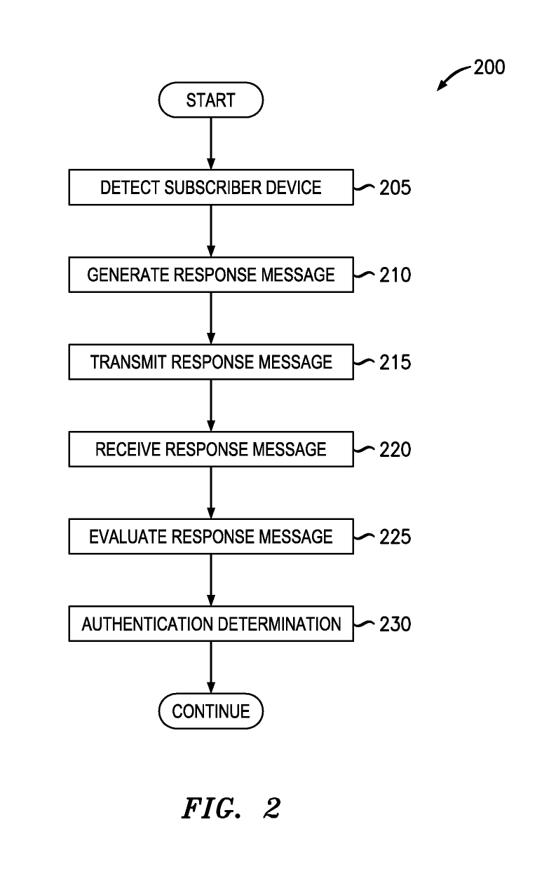

FIG. 2 is a flow diagram illustrating an authentication method 200 according to an embodiment of the present invention. At START it is presumed that the necessary components are available and operational according to at least this embodiment. The process then begins when a managing node in an optical access network detects (step 205) the presence of a new subscriber device. The managing node may be, for example, an OLT in a central office of a service provider, and the subscriber device may be an ONU. Note that a ‘new’ subscriber device may be one that has previously formed a part of the access network, but that has for some reason been out of regular operation.

In this embodiment, when the subscriber device is detected, the managing node generates (step 210) a request message that includes an encryption key. The request message may also in some embodiments include a key validator. The generated message is then transmitted (step 215) to the detected subscriber device.

In one preferred embodiment where the managing device is a GPON OLT, the request message is a Password Request PLOAM message and, for example, makes use of unspecified message bytes, including using eight of the unspecified bytes for the encryption key and 2 of the unspecified bytes for an encryption key validator.

In the embodiment of FIG. 2, the managing node then receives (step 220) a response to the request message. Note that if no response is received, the managing node may then simply continue with (other) normal operations and ignore the detected device. It may also re-transmit (not shown) the request message after a certain period of time has passed or at selected intervals until a response is received.

In the embodiment of FIG. 2, when the managing node receives the response, it performs an evaluation (step 225) of the response. Based in whole or in part on the results of this evaluation, the managing node then determines (step 230) whether to authenticate the subscriber device for operation within the optical access network. The managing node then continues with network operations, inclusive or exclusive of the subscriber device depending on the results of the determination.

The exact process used to evaluate a received response may vary by implementation. In essence, however, a legitimate subscriber device is equipped with an encryption algorithm that enables it to utilize the encryption key contained in the request from the managing node to encrypt its response. The response is then evaluated to determine if it has been properly encrypted. Note that the entire response message may but need not be encrypted. The managing node looks for an encrypted text string or password that has been previously stored in the subscriber device. Generally speaking, if the managing node receives a response containing a badly encrypted or unencrypted test string or password, the subscriber device will not be authenticated.

In an embodiment where the request is a PLOAM message, the response will be a Password PLOAM. In this embodiment, the managing node may evaluate the response by first comparing the password in the message to an unencrypted version (which is known to the managing node). A match indicates that the password was not properly encrypted and the authentication will fail. If, on the other hand, the comparison fails, then the received password is compared to an encrypted version (also known to the managing node). If this second comparison is successful, the managing node may determine that the subscriber device should be authenticated for operation in the network. Alternatively, the managing node may decrypt the password before performing the second comparison, comparing the decrypted password to an unencrypted version. Note that the managing node may use a successful evaluation as the sole criterion for determining whether to authenticate the subscriber device or alternatively may use other criteria as well.

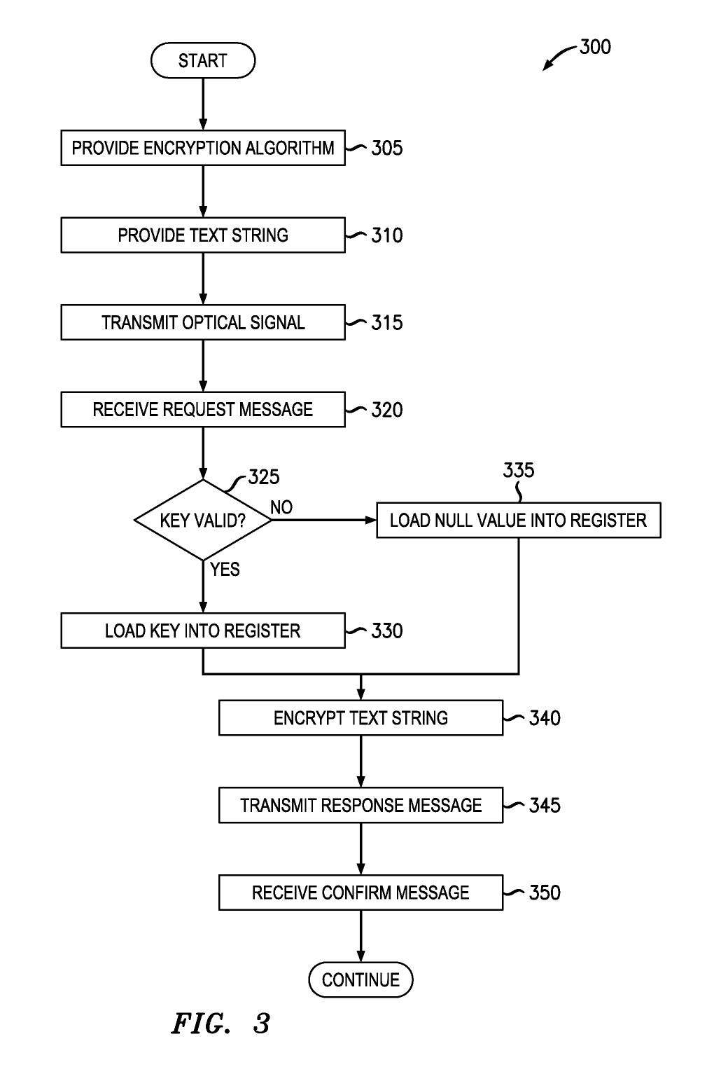

FIG. 3 is a flow diagram illustrating an authentication method 300 according to another embodiment of the present invention. At START it is presumed that the necessary components are available and operational according to at least this embodiment. The process then begins when a subscriber device is provided with an encryption algorithm (step 305). The subscriber device may be, for example, an ONU for use in a PON or other optical access network. In a preferred embodiment, the encryption algorithm is formed on an SoC that is used to implement the subscriber device. In this case, of course, the encryption algorithm is normally provided at manufacture; in other embodiments it may be provided in some suitable after-market environment. It is normally highly desirable, of course, to keep the encryption algorithm confidential and proprietary.

In the embodiment of FIG. 3, the subscriber device is also provided (step 310) with a text string that may be used for authentication according to the present invention. The text string may also be provided at manufacture or at some later time. Note that as used herein, the term “text string” is broadly used, while “password” is mostly associated with the transmission of PLOAM messages. In claiming the invention, however the terms are considered equivalent unless an explicit distinction is recited.

In the embodiment of FIG. 3, the subscriber device transmits an optical signal (step 315) that can be detected by a managing node, such as an OLT in a PON. Presuming that the subscriber device is connected at this point to a functioning optical access network, it should eventually receive (step 320) a request that includes an encryption key. In this embodiment, the request also includes an encryption key validator. The subscriber device may then perform key validation (step 325).

In this embodiment, if the key is determined by the subscriber device to be valid, it is loaded into a register (step 330). If the key is determined to be invalid, a null value is loaded (step 335) instead. In a preferred embodiment, the register is formed onto the SoC implementing the subscriber device.

In the embodiment of FIG. 3, the text string is then encrypted (step 340) using the resident encryption algorithm and the value stored in the encryption key register. The encrypted text string is then transmitted (step 345) in a response message to the managing device. As should be apparent, proper encryption will only result when the correct encryption key and algorithm are employed. A pirated device may attempt to respond to the received request, but should not be able to form the response properly. For a legitimate device, it is expected that the managing node will discern the proper response (see, for example, FIG. 2) and authorize the subscriber device for operation in the network.

In the embodiment of FIG. 3, after the response message is transmitted, the subscriber device receives a confirmation message (step 350) indicating whether authentication was successful. Presuming that the subscriber device is legitimately connecting to the PON network, a negative confirmation message may indicate a problem or at least the need to attempt authentication again (not shown). The process then continues as the subscriber device operates within the PON.

Note that the sequences of operation illustrated in FIGS. 2 and 3 represent exemplary embodiments; some variation is possible within the spirit of the invention. For example, additional operations may be added to those shown in FIGS. 2 and 3, and in some implementations one or more of the illustrated operations may be omitted. In addition, the operations of the method may be performed in any logically-consistent order unless a definite sequence is recited in a particular embodiment.

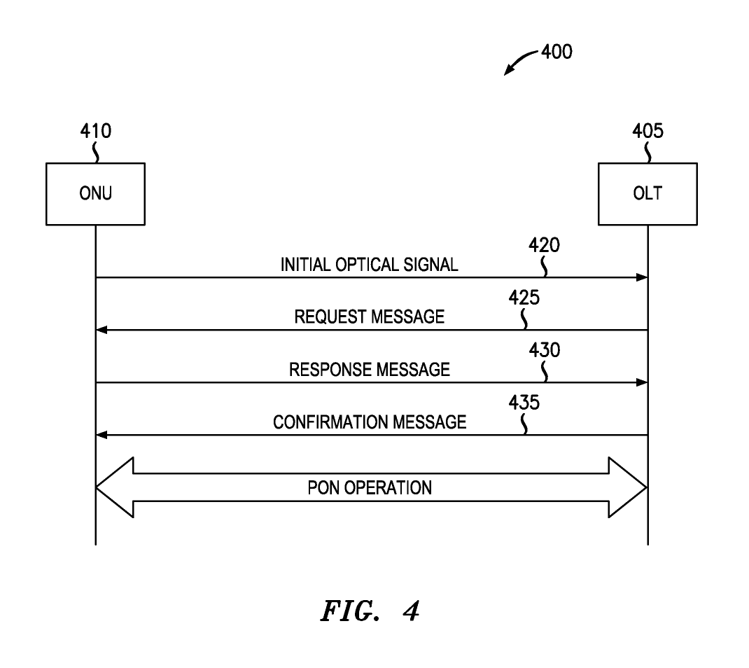

FIG. 4 is a message flow diagram illustrating an authentication method 400 according to another embodiment of the present invention. Shown in FIG. 4 are an OLT 405 and an ONU 410. It is noted that in a PON environment, communications between an OLT and an ONU typically pass though a splitter/combiner. The splitter/combiner in this PON is a passive device, however, and therefore omitted from the depiction of FIG. 4. It is also noted here that the message flow of FIG. 4 is analogous though not necessarily identical to a combination of FIGS. 2 and 3.

In the embodiment of FIG. 4, it is presumed that the ONU 410 is not currently an operational component of the PON, that is, it has been connected to a fiber associated with the PON, but is not yet recognized by the OLT. The flow begins when the ONU sends an initial transmission 420, for example on being powered-up by a subscriber. The OLT 405 receives the initial transmission 420 and sends a request 425, for example a PLOAM password request, to the ONU 410.

In accordance with this embodiment of the present invention, the request 425 includes an encryption key and a key validation code. The ONU 410 processes this request and returns a response 430, for example a Password PLOAM message, to the OLT 405. In this embodiment, the OLT 405, after evaluating the response 430, transmits a confirmation 435, which indicates whether the authentication process was successful. Note that a confirmation message is not required in that successful authentication may simply result in normal PON operation including the subscriber device, while unsuccessful authentication may simply result in the subscriber device being ignored.

Although not shown in FIG. 4, the confirmation message 435 may allow a legitimate subscriber device that has failed authentication to make another attempt (not shown). Also, in some implementations the network operator may be notified of a failed authentication in order to address the existence of a possible illegitimate device attempting to operate in the PON.

Note that the sequence of message flow illustrated in FIG. 4 represents an exemplary embodiment; some variation is possible within the spirit of the invention. For example, additional messaging may be added to that shown in FIG. 4, and in some implementations one or more of the illustrated messages may be omitted. In addition, the messages of the method may be transmitted and received in any logically-consistent order unless a definite sequence is recited in a particular embodiment.

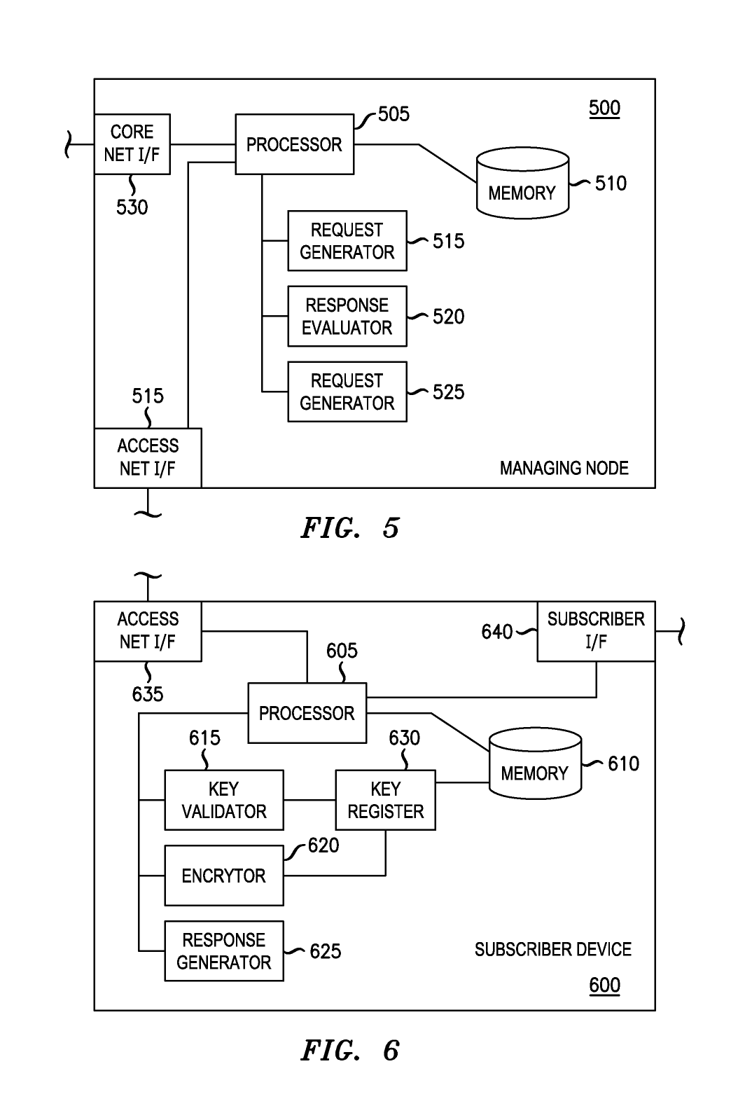

FIG. 5 is a simplified block diagram illustrating selected components of a managing node 500 configured according to an embodiment of the present invention. In this embodiment, the managing node 500 includes a processor 505 and a memory device 510. Memory device 510 in this embodiment is a physical storage device that may in some cases operate according to stored program instructions. In any case, memory 510 is non-transitory in the sense of not being merely a propagating signal. Memory 510 is used for storing, among other things, data and stored program instructions for execution by processor 505.

In the embodiment of FIG. 5, managing node 500 also includes a request generator 515 for generating password/text string request messages and a response evaluator 520 for evaluating responses to the request that have been received from subscriber devices. A decryptor 525 may be used to decrypt all or part of a received response for evaluation. Request generator 515, response evaluator 520 and decryptor 525 may be implemented as hardware or as software program instructions executing on a processor, or a combination of both. They may each or all be integrated with processor 505 or each other, or implemented as separate devices (as depicted in FIG. 5).

Finally, in the embodiment of FIG. 5, managing node 500 also includes an access network interface 535, through which managing node 500 communicates with various subscriber devices (see, for example, FIG. 1), as well as a core network interface 530 for communicating with a core network.

Note again that FIG. 5 illustrates selected components of an embodiment of the present invention and some variations are possible without departing from the claims of the invention as there recited. In some of these embodiments, illustrated components may be integrated with each other or divided into subcomponents. There will often be additional components in the device management server and in some cases less. The illustrated components may also perform other functions in addition to those described above.

FIG. 6 is a simplified block diagram illustrating a subscriber device 600 configured according to an embodiment of the present invention. In this embodiment, the subscriber device 600 includes a processor 605 and a memory device 610. Memory device 610 in this embodiment is a physical storage device that may in some cases operate according to stored program instructions. In any case, memory 610 is non-transitory in the sense of not being merely a propagating signal. Memory 610 is used for storing, among other things, data and stored program instructions for execution by processor 605.

In the embodiment of FIG. 6, subscriber device 600 also includes a key validator 615 for validating an encryption key expected in an authorization-related request from a managing node. A key register 620 is provided for storing the encryption key. An encryptor 625 is present to encrypt a text string or password for inclusion in a response to the request, which is generated by response generator 630. Key validator 615, encryptor 625, and response generator 630 may be implemented as hardware or as software program instructions executing on a processor, or a combination of both. Key register 620 is preferably implemented in hardware. They may each or all be integrated with processor 605 or each other, or implemented as separate devices (as depicted in FIG. 6).

Finally, in the embodiment of FIG. 6, subscriber device 600 also includes an access network interface 635, through which subscriber device 600 communicates with a (see, for example, FIG. 1), as well as a subscriber interface 640 for communicating with one or more subscriber devices (or other network components connecting the subscriber device to one or more subscriber devices).

Note again that FIG. 6 illustrates selected components of an embodiment of the present invention and some variations are possible without departing from the claims of the invention as there recited. In some of these embodiments, illustrated components may be integrated with each other or divided into subcomponents. There will often be additional components in the device management server and in some cases less. The illustrated components may also perform other functions in addition to those described above.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. A method of authenticating a subscriber device for operation in an optical access network, comprising:
receiving a request at a subscriber device; the request comprising an encryption key;
encrypting at least a portion of a response using the encryption key; and
transmitting the encrypted response from the subscriber device.

2. The method of claim 1, wherein the request further comprises a key validation code and wherein the method further comprises determining whether the key is valid.

3. The method of claim 2, further comprising loading the key into a register prior to encrypting if the key is determined to be valid.

4. The method of claim 3, further comprising loading a null value into the register prior to encrypting if the key is determined to be not valid.

5. The method of claim 1, wherein the at least a portion of the response is a text string extant in the subscriber device.

6. The method of claim 1, further comprising detecting the subscriber device by a managing node of the optical access network.

7. The method of claim 1, further comprising generating and transmitting the request by a managing node of the optical access network.

8. The method of claim 1 further comprising:
receiving the at least partially encrypted response at a network authentication device; and
evaluating the response.

9. The method of claim 8, wherein evaluating comprises determining whether the encrypted portion of the response has been properly encrypted according to a known encryption algorithm.

10. The method of claim 8, further comprising decrypting the encrypted portion of the response.

11. The method of claim 8, further comprising determining whether to authenticate the subscriber device for network operation based at least in part on the evaluation.

12. The method of claim 8, wherein the managing node is an OLT.

13. The method of claim 1, wherein the subscriber device is an ONU.

14. The method of claim 1, wherein the request is a PLOAM message.
